(19) United States
(12) Patent Application Publication
(10) Pub. No.: US 2026/0292442 A1
(43) Pub. Date: Sep. 24, 2026

(54) Server and Method for Connecting Users Through Shared Interests in Real-World Event

(71) Applicant: Hayden John Normand Jordahl, Nelson (CA)

(72) Inventor: Hayden John Normand Jordahl, Nelson (CA)

(21) Appl. No.: 19/085,464

(22) Filed: Mar. 20, 2025

(51) Int. Cl. H04W 4/024; H04L 67/30; H04W 4/02

(52) U.S. Cl. CPC H04W 4/024; H04L 67/30; H04W 4/025

(57) ABSTRACT

The present disclosure provides a server, a method and a computer program product for facilitating social connection between users at a real-world event. The server receives first user input to select first real-world event to be attended by first user. Ther server determines first set of users, from a set of users, attending the first real-world event based on the received first user input, and renders first set of user profiles associated with the first set of users on the first user device. The server further renders location information associated with the first real-world event, on the first user device and a second user device associated with the second user, wherein the location information comprises a location scheduled to meetup at the first real-world event.

### BACKGROUND OF THE INVENTION

### Technological Field

The disclosure relates to social networking, and more specifically, to a server and a method for facilitating social connections between users in real-world events.

### Background

In today's digital age, online networking has revolutionized the way individuals connect, share ideas, and build relationships. Various social media platforms leverage robust internet connectivity and advanced algorithms to allow individuals reach a global audience, facilitating communication and collaboration across geographical boundaries. Further, such platforms enable the individuals to expand their networks, share expertise, and participate in online communities without the constraints of physical location. However, despite its advantages, online networking has several limitations associated therewith. One of the major drawbacks of such digital revolution is lack of physical interaction that may lead to feelings of isolation and loneliness in an individual. Further, the online networking may feel impersonal and less engaging, thereby making it challenging to build genuine connections.

Therefore, there is a need for a more specialized approach that helps the individuals discover in-person events and fosters a sense of community by connecting individuals with similar interests. Further, attending events physically may provide opportunities for meaningful connections, networking and personal growth.

### SUMMARY OF THE INVENTION

A server, a method, and a computer programmable product are provided herein that focuses on facilitating social connections between users in real-world events.

In one aspect, a server for connecting users in real-world events is provided. The server includes a memory to store a computer-executable instructions, and a processor configured to execute the computer-readable instructions to perform the actions. The processor may be configured to receive a first user input indicative of a selection of a first real-world event to be attended by a first user. The first user input is received from a first user device associated with the first user. The processor may be further configured to determine a first set of users, from a set of users, attending the first real-world event based on the received first user input. The first set of users includes at least a second user. The processor may be further configured to render a first set of user profiles associated with the first set of users on the first user device. The processor may be further configured to render location information associated with the first real-world event on the first user device and a second user device associated with the second user. The location information includes a location scheduled to meetup at the first real-world event.

In additional server embodiments, the processor may be further configured to receive a second user input indicative of a selection of one or more user profiles from the first set of user profiles, using the first user device. Further, the processor may be configured to generate a first notification indicative of a request for the second user to connect with the first user at the first real-world event based on the second user input. Thereafter, the processor may be configured to transmit the first notification to the second user device and render the first notification.

In additional server embodiments, the processor may be configured to receive a third user input to acknowledge the first notification. The third user input is received from the second user device.

In additional server embodiments, the processor may be configured to receive a first search query pertaining to event data associated with a set of real-world events. The first search query is received from the first user device. The processor may be further configured to determine a first set of real-world events from the set of real-world events based on the received first search query. The processor may be further configured to render the first set of real-world events on the first user device. The processor may be further configured to receive the first user input to select the first real-world event from the first set of real-world events.

In additional server embodiments, the event data associated with the set of real-world events includes a type of an event for each of the set of real-world events, a location information associated with the event for each of the set of real-world events, and a timestamp of an entry to the event for each of the set of real-world events.

In additional server embodiments, the processor may be further configured to receive the event data associated with the set of real-world events from one or more hosts and store the event data.

In additional server embodiments, the processor may be further configured to generate a second notification that pertains to a request to attend the first real-world event. Further, the processor may be configured to transmit the second notification to the first user device. Furthermore, the processor may be configured to receive the first user input to select the first real-world event based on the second notification.

In additional server embodiments, each of the first set of user profiles associated with the first set of users comprises demographic data associated with a corresponding user of the first set of users, and preference data associated with the corresponding user of the first set of users.

In additional server embodiments, the processor may be further configured to receive a first user profile associated with the first user. The first user profile comprises demographic data associated with the first user and preference data associated with the first user. The processor may be further configured to compare the first user profile with each profile of the first set of user profiles and determine a score for each of the first set of user profiles based on the comparison. The processor may be further configured to render the first set of user profiles on the first user device based on the determined score.

In another aspect, a method for connecting users in real-world events is provided. The method may include receiving a first user input indicative of a selection of a first real-world event to be attended by a first user. The first user input is received from a first user device associated with the first user. The method may further include determining a first set of users, from a set of users attending the first real-world event based on the received first user input. The first set of users includes at least a second user. Further, the method may include rendering a first set of user profiles associated with the first set of users on the first user device. The method may include rendering location information associated with the first real-world event, on the first user device and a second user device associated with the second user. The location information includes a location scheduled to meetup at the first real-world event.

In additional method embodiments, the method may further include receiving a second user input indicative of a selection of one or more user profiles from the first set of user profiles, using the first user device. Further, the method may include generating a first notification indicative of a request for the second user to connect with the first user at the first real-world event based on the second user input. Thereafter, the method may include transmitting the first notification to the second user device and render the first notification.

In additional method embodiments, the method may further include receiving a third user input to acknowledge the first notification. The third user input is received from the second user device.

In additional method embodiments, the method may further include receiving a first search query pertaining to event data associated with a set of real-world events. The first search query is received from the first user device. The method may further include determining a first set of real-world events from the set of real-world events based on the received first search query. The method may further include rendering the first set of real-world events on the first user device. The method may further include receiving the first user input to select the first real-world event from the first set of real-world events.

In additional method embodiments, the event data associated with the set of real-world events includes a type of an event for each of the set of real-world events, a location information associated with the event for each of the set of real-world events, and a timestamp of an entry to the event for each of the set of real-world events.

In additional method embodiments, the method may further include receiving the event data associated with the set of real-world events from one or more hosts and storing the event data.

In additional method embodiments, the method may further include generating a second notification that pertains to a request to attend the first real-world event. Further, the method may further include transmitting the second notification to the first user device. Furthermore, the method may further include receiving the first user input to select the first real-world event based on the second notification.

In additional method embodiments, each of the first set of user profiles associated with the first set of users comprises demographic data associated with a corresponding user of the first set of users, and preference data associated with the corresponding user of the first set of users.

In additional method embodiments, the method may further include receiving a first user profile associated with the first user. The first user profile comprises demographic data associated with the first user and preference data associated with the first user. The method may further include comparing the first user profile with each profile of the first set of user profiles and determining a score for each of the first set of user profiles based on the comparison. The method may further include rendering the first set of user profiles on the first user device based on the determined score.

In yet another aspect, a non-transitory computer-readable storage medium carrying one or more sequences of one or more instructions which, when executed by at least one processor, cause a system to perform operations comprising receiving a first user input indicative of a selection of a first real-world event to be attended by a first user. The first user input is received from a first user device associated with the first user. The operations may further include determining a first set of users, from a set of users, attending the first real-world event based on the received first user input. The first set of users includes at least a second user. Further, the operations may include rendering a first set of user profiles associated with the first set of users on the first user device. The operations may include rendering location information associated with the first real-world event on the first user device and a second user device associated with the second user. The location information includes a location scheduled to meetup at the first real-world event.

In additional computer program product embodiments, the operations may further include receiving a second user input indicative of a selection of one or more user profiles from the first set of user profiles, using the first user device. Further, the operations may include generating a first notification indicative of a request for the second user to connect with the first user at the first real-world event based on the second user input. Thereafter, the operations may include transmitting the first notification to the second user device and render the first notification.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF FIGURES

Having thus described example embodiments of the invention in general terms, reference will now be made to the accompanying drawings, which are not necessarily drawn to scale, and wherein:

FIG. 1 is a diagram that illustrates a network environment for connecting users in the real-world events, in accordance with an embodiment of the disclosure;

FIG. 2 illustrates a block diagram of the server of FIG. 1, in accordance with an embodiment of the disclosure;

FIG. 3 is a diagram that illustrates exemplary operations for connecting users in the real-world event, in accordance with an embodiment of the disclosure;

FIG. 4 is a diagram that illustrates exemplary operations for determining scores for each user profile, in accordance with an embodiment of the disclosure;

FIG. 5A, FIG. 5B, FIG. 5C and FIG. 5D illustrate exemplary user interfaces for connecting users in the real-world event, in accordance with an embodiment of the disclosure;

FIG. 6A illustrates exemplary user interface associated with display of a first user profile, in accordance with an embodiment of the disclosure;

FIG. 6B illustrates exemplary user interface associated with rendering of the first notification on a second user device, in accordance with an embodiment of the disclosure;

FIG. 7 illustrates exemplary user interface for notifying users about the real-world event, in accordance with an embodiment of the disclosure; and

FIG. 8 is a flowchart that illustrates an exemplary method for facilitating social connections between users in the real-world event, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all refer to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received, and/or stored in accordance with embodiments of the present disclosure. Thus, the use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

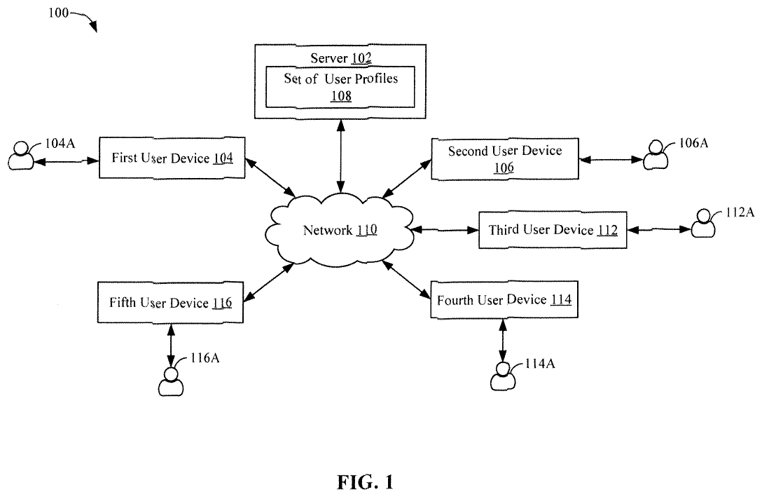

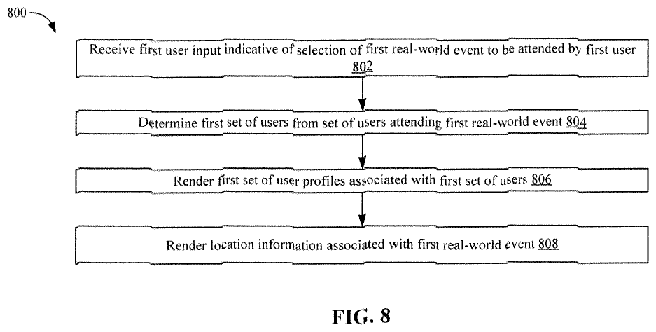

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect. Turning now to FIG. 1 FIG. 8, a brief description concerning the various components of the present disclosure will now be briefly discussed. Reference will be made to the figures showing various embodiments of a server for facilitating social connections between users in the real-world events.

FIG. 1 is a diagram that illustrates a network environment for connecting users in the real-world events, in accordance with an embodiment of the disclosure. With reference to FIG. 1, there is shown a diagram of the network environment 100. The network environment 100 includes a server 102, and a network 110. The server102 may further include set of user profiles 108. With reference to FIG. 1, there is further shown a first user device 104, a second user device 106, a third user device 112, a fourth user device 114, and a fifth user device 116 associated with a first user 104A, a second user 106A, a third user 112A, a fourth user 114A, and a fifth user 116A, respectively.

Further, the first user device 104, the second user device 106, the third user device 112, the fourth user device 114, and the fifth user device 116 may be collectively referred as user devices hereinafter. It is to be noted that the user devices are depicted merely as an example, a number of user devices may vary without departing from the scope of invention.

The user devices may include suitable logic, circuitry, and/or interfaces that may be designed for a specific task within the network environment 100. The user devices may play a crucial role in receiving requests from the user, processing data, and delivering the data efficiently. The user devices may be designed for high-performance computing and data handling, ensuring that the user requests may be handled accordingly and that the requested content is delivered to the user seamlessly. Examples of the user devices may include, but are not limited to, a smartphone, a mobile phone, a computing device, a tablet, wearable digital device, or a laptop.

The server 102 may be embodied as a cloud-based service, a cloud-based application, a cloud-based platform, a remote server-based service, a remote server-based application, a remote server-based platform, or a virtual computing system. In each of the embodiments, the server 102 may be communicatively coupled to the components shown in FIG. 1 to carry out the desired operations and wherever required modifications may be possible within the scope of the present disclosure. Load balancing and redundancy further enhance the reliability, and the one or more servers in various locations worldwide to facilitate social connections between the users anywhere around the globe. For example, the server 102 may include but is not limited to, a mail server, a data server, an application server, or a database server.

In various embodiments, the server 102, and the user devices are connected over the network 110 for data transmission. The network 110 may be wired, wireless, or any combination of wired and wireless communication networks, such as cellular, Wi-Fi, internet, local area networks, or the like. In some embodiments, the network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In operation, the server 102 may be configured to facilitate social connections between one or more users (for example, the first user 104A, the second user 106A, the third user 112A, the fourth user 114A, and the fifth user 116A) that may be attending a real-world event. In some embodiments, examples of the real-world event may include, but are not limited to a sporting event, an exhibition, a music concert, a festival, a graduation ceremony, a trade show, a charity fundraiser, an art gallery opening, a product launch, a movie premiere, a cultural celebration, an awards ceremony, a wedding, a birthday party, a conference, and a business seminar.

Embodiments of the present disclosure enable a user, say the first user 104A to develop and foster new connections and experiences with other users, say the second user 106A and/or the third user 112A. By closing a loop and leveraging ethical meetup methods, the server 102 helps users to connect in person at their desired real-world event or activities.

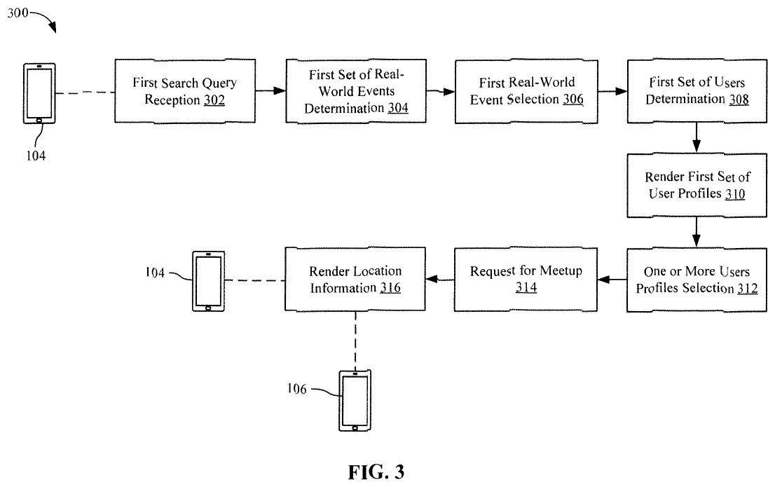

In an embodiment, the server 102 may receive a first user input indicative of a selection of a first real-world event to be attended by the first user 104A. The first user input may be received from a first user device 104 associated with the first user 104A. Details associated with the reception of the first user input are provided, for example, in FIG. 3.

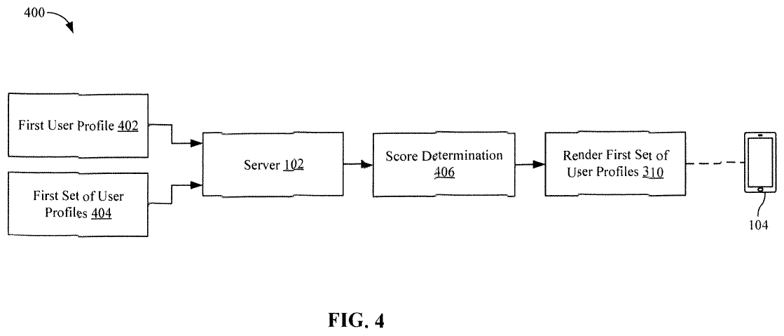

Further, the server 102 may determine a first set of users from a set of users who are attending the first real-world event based on the received first user input. The first set of users includes at least the second user 106A. In various embodiments, the first set of users are individuals who attend the event such as a viewer, an attendee, a guest, an organizer, and an audience participant. In an example the first set of users may include, but are not limited to, the second user 106A, the third user 112A, the fourth user 114A, and the fifth user 116A. Details associated with the determination of the first set of users are provided, for example, in FIG. 3 and FIG. 4.

Thereafter, the server 102 may render a first set of user profiles associated with the first set of users on the first user device 104. In an embodiment, each of the first set of user profiles associated with the first set of users includes demographic data associated with a corresponding user of the first set of users, and preference data associated with a corresponding user of the first set of users. The demographic data corresponds to information associated with a user (for example, the second user 106A, the third user 112A, the fourth user 114A, and the fifth user 116A) that may describe a group of individuals. The demographic data may include, but is not limited to age data, gender data, ethnicity data, marital status, and socioeconomic status. The age data may correspond to an age of the second user 106A. The age data may indicate specific age group to which the second user 106A may belong. The gender data may indicate gender of the second user 106A. The ethnicity data may indicate specific race or ethnicity of the second user 106A. The marital status may indicate whether the second user 106A is married. The socioeconomic status may indicate various socioeconomic factors such as income, employment status, educational background, or lifestyle.

The preference data corresponds to information associated with the user (for example, second user 106A, the third user 112A, the fourth user 114A, and the fifth user 116A) that may describe an area of interest of an individual. Examples of the area of interest may include, but are not limited to, hobbies such as hiking, cooking, reading, gaming, travelling, music, sports and the like.

Further, the server 102 may render location information associated with the first real-world event on the first user device 104 and the second user device 106. The location information includes a location scheduled to meetup at the first real-world event. Details associated with the meetup of the users at the first real-world event are provided, for example, in FIG. 3.

In an embodiment, the server 102 may be communicatively coupled to other components not shown in FIG. 1 via the network 110. All the components in the network environment 100 may be coupled directly or indirectly to the network 110. The components described in the network environment 100 may be further broken down into more than one component and/or combined in any suitable arrangement. Further, one or more components may be rearranged, changed, added, and/or removed.

While online networking provides valuable tools for connecting and collaborating with individuals, it cannot fully replace the depth and authenticity of face-to-face interactions. The present disclosure addresses the challenges by providing specialized approach that facilitates the first user 104A to discover the real-world events that he or she may attend. Additionally, the present disclosure aids the first user 104A to find the first set of users (for example, the second user 106A, the third user 112A, the fourth user 114A, and the fifth user 116A) that may be attending the same real-world events, thereby creating a vibrant community where the first user 104A may socially connect with the other users with similar interests and attending the same real-world events. This may further enhance overall experience of users attending the real-world events and promote new social connections, thereby creating a sense of community between the users. Further, the users frequently face challenges in finding companions to attend the real-world events, especially when their immediate social circles do not share the same interest. Therefore, the present disclosure provides a server and a method for facilitating social connections between users in the real-world events, thereby helping them to engage and enjoy the real-world events with like-minded users that share similar interests.

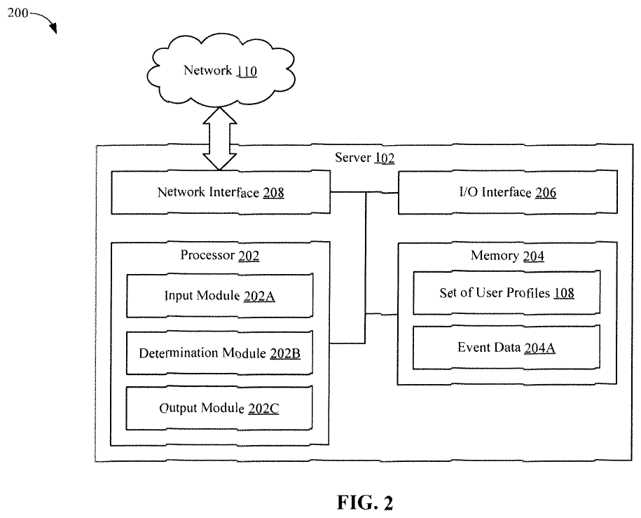

FIG. 2 illustrates a block diagram 200 of the server 102 of FIG. 1, in accordance with an embodiment of the disclosure. FIG. 2 is explained in conjunction with FIG. 1. The server 102 may include at least one processor 202 (referred to as a processor 202, hereinafter), at least one non-transitory memory 204 (referred to as a memory 204, hereinafter), an input/output (I/O) interface 206, and a network interface 208. The processor 202 is coupled to the memory 204 and executes the computer-executable instructions. Further, the processor 202 may be connected to the memory 204, and the I/O interface 206 through wired or wireless connections. Although in FIG. 2, it is shown that the server 102 includes the processor 202, the memory 204, and the I/O interface 206 however, the disclosure may not be so limiting and the server 102 may include fewer or more components to perform the same or other functions of the server 102.

In an example, the processor 202 includes various modules, such as, an input module 202A, a determination module 202B, and an output module 202C. In operation, the processor 202, specifically the input module 202A, is configured to receive a first search query to discover real-world events. The first search query may include a word, or a phrase to find specific information. Such an input may guide a search engine to retrieve relevant documents, websites, or data based on the word, or the phrase provided.

In this regard, the determination module 202B may be configured to determine a first set of real-world events for the first user 104A based on the first search query. By way of example, the input module 202A may receive the first search query including keywords like trade show. The determination module 202B may be configured to determine the first set of real-world events for the first user 104A. In this example, the first set of real-world events may include various trade shows, such as, but not limited to consumer electronics show, import export fair, automotive expo, fashion trade show, and the like.

In an example, the output module 202C may be configured to render the first set of real-world events on the first user device 104. Thereafter, the input module 202A may be configured to receive a first user input indicative a selection of a first real-world event from the first set of real-world events. Upon selection, the processor 202, specifically the determination module 202B, may be configured to determine a first set of users (for example, the second user 106A, the third user 112A, the fourth user 114A, and the fifth user 116A) attending the first real-world event based on the received first user input. Thereafter, the processor 202 may facilitate rendering the first set of user profiles associated with the determined first set of users on the first user device 104. In an example, the processor 202 may be further configured to render location information associated with the first real world event on the first user device 104 and the user devices (for example, the second user device 106, the third user device 112, the fourth user device 114, and the fifth user device 116) associated with the first set of users.

It may be noted, the processor 202 may facilitate a user, such as the first user 104A to create an account. In an example, the first user 104A may provide user information, such as, but not limited to, name, age, gender, photo, email address, contact information, location data, user Id, password, pin, and the like. In an example, the processor 202 is configured to create an account for the first user 104A based on authentication of the email address and/or the contact information. Subsequently, the first user 104A may access their account over the server 104 by logging-in on the server 104. In this regard, the first user 104A may further log in on the server 104 using their email address, contact details, user Id, password, pin, or a combination thereof. In a similar manner, other users, such as the second user 106A, the third user 112A, the fourth user 114A and the fifth user 116A of the server 104 may create account and/or log-in to their account on the server 104.

The processor 202 of the server 102 may be configured to facilitate social connections between a first set of users at the first real-world event. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the server 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network 110 may be accessed using the network interface 208 of the server 102. The network interface 208 may provide an interface for accessing various features and data stored in the server 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the server 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein. In an embodiment, the memory 204 may be configured to store the set of user profiles 108 and event data 204A. In an embodiment, the set of user profiles 108 may include a first user profile associated with the first user 104A, and a first set of user profiles associated with a first set of users. The first user profile includes demographic data associated with the first user 104A, and preference data associated with the first user 104A.

In some example embodiments, the I/O interface 206 may communicate with the server 102 and display the input and/or output of the server 102. As such, the I/O interface 206 may include a display and, in some embodiments, may also include a keyboard, a mouse, a touch screen, touch areas, soft keys, or other input/output mechanisms. In one embodiment, the server 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry including the processor 202 may be configured to control one or more functions of one or more I/O interface 206 elements through computer program instructions (for example, software and/or firmware) stored on a memory 204 accessible to the processor 202. The I/O interface 206 may provide an interface for accessing various features and data stored in the server 102. For example, the I/O interface 206 which may be in the form of a GUI, a touch interface, a voice-enabled interface, a keypad, and the like.

The network interface 208 may include the input interface and output (I/O) interface for supporting communications to and from the server 102 or any other component with which the server 102 may communicate. The network interface 208 may be any means such as a device or circuitry embodied in either hardware or a combination of hardware and software that is configured to receive and/or transmit data to/from a communications device in communication with the server 102. In this regard, the network interface 208 may include, for example, an antenna (or multiple antennae) and supporting hardware and/or software for enabling communications with a wireless communication network. Additionally, or alternatively, the network interface 208 may include the circuitry for interacting with the antenna(s) to cause transmission of signals via the antenna(s) or to handle receipt of signals received via the antenna(s). In some environments, the network interface 208 may alternatively or additionally support wired communication. As such, for example, the network interface 208 may include a communication modem and/or other hardware and/or software for supporting communication via cable, digital subscriber line (DSL), universal serial bus (USB), or other mechanisms.

FIG. 3 is a diagram that illustrates exemplary operations for connecting users in the real-world event, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 316, as described herein. The exemplary operations illustrated in the block diagram 300 may start at 302 and may be performed by any computing system, apparatus, or device, such as by the server 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the implementation.

At 302, a first search query may be received. In an embodiment, the processor 202 may be configured to receive the first search query pertaining to event data 204A associated with the first real-world event. The event data 204A associated with the first real-world event may include event type information, location information, and timestamp information. The event type information may correspond to information associated with a type of the real-world event. Examples of the event type information include, but are not limited to a sporting event, an exhibition, a music concert, a festival, a graduation ceremony, a trade show, a charity fundraiser, an art gallery opening, a product launch, a movie premiere, a cultural celebration, an awards ceremony, a wedding, a birthday party, a conference, and a business seminar. The location information may correspond to information associated with a geographical location of the real-world event. The timestamp information may correspond to information associated with time of entry or a duration of the real-world event.

In an embodiment, the processor 202 may be configured to receive the event data 204A from one or more hosts. Further, the one or more hosts may be individuals who organize such real-world events. The processor 202 may receive the event data 204A from a user device over the network 110 and store the event data 204A in the memory 204. In an embodiment, the user device may be associated with the at least a first host that may be organizing the real-world event. Examples of the user device may include, but are not limited to, a smartphone, a mobile phone, a computing device, a tablet, or a laptop.

In an example, the processor 202 and the server 104 implements an application accessible by the users. The users may create account and log-in on the application to create an event, i.e., post the event data about a real-world event that they are hosting, or view an event, i.e., provide the first search query to search for the real-world event. The home page gives users the ability to only search desired events/activities, such as by transmitting the first search query, and also allows users to scroll through events. These events that a user may scroll through may be suggested to the user based on their interests, such as profile data, previous events that the user has attended, organizers or host profiles that the user follows, and/or organizers or host profiles associated with the previous events that the user has attended.

At 304, a first set of real-world events may be determined. In an embodiment, the processor 202 may be configured to determine a first set of real-world events from a set of real-world events based on the first search query. By way of example, the processor 202 may receive the first search query pertaining to the event data 204A from the first user device 104. In an example the first user 104A may input the first search query as a text input using the first user device 104. In another example, the first user 104A may input the first search query as an audio input using the first user device 104.

Upon receiving the first search query, the processor 202 may be configured to determine the first set of real-world events relevant to the first search query. For example, the first user 104A may input the first search query, for example “music concert” using the first user device 104 to determine various music concerts happening in the real-world nearby or pertinent to the location of the first user 104A. When the first user 104A enters the first search query, the processor 202 (or the determination module 202B) may retrieve relevant first set of real-world events from the internet. Thereafter, the processor 202 may be configured to render the determined first set of real-world events. For example, the first set of real-world events may include a list of music concerts happening in a city or a country in which the first user 104A resides. For example, the first set of real-world events may include music concerts performed by different artists, music concerts performed a same artist across different regions, and/or music concerts of different genres of music.

At 306, the first real-world event may be selected. In an embodiment, the processor 202 may be configured to receive a first user input to select the first real-world event from the first set of real-world events to be attended by the first user 104A. By way of example, the first set of real-world events may be displayed on a display screen associated with the first user device 104. Example of the display screen may include, but is not limited to, a Liquid Crystal Display (LCD), a Light Emitting Diode (LED)-based display, and an Organic LED (OLED)-based display. Thereafter the processor 202 may receive the first user input indicative of a selection of the first real world event to be attended by the first user 104A. The first user input may be for example, but not limited to a touch input, a gesture input or an audio input.

At 308, a first set of users may be determined. In an embodiment, the processor 202 may be configured to determine the first set of users (for example, including the second user 106A, the third user 112A, the fourth user 114A, and the fifth user 116A) from a set of users attending the first real-world event based on the received first user input. The first set of users includes at least the second user 106A. The set of users may correspond to a group of individuals who may have an account with the application executed by the processor 202 or the server 104. Further the set of users may include the first set of users that are attending the real-world event.

At 310, the first set of user profiles may be rendered. In an embodiment, the processor 202 may be configured to render the first set of user profiles associated with the first set of users on the first user device 104. Each of the first set of user profiles associated with the first set of users includes demographic data and preference data, as described, for example, in FIG. 1.

At 312, one or more user profiles may be selected. In an embodiment, the processor 202 may be configured to receive a second user input indicative of a selection of the one or more user profiles from the first set of user profiles, using the first user device 104. The second user input may be for example, but not limited to a touch input, a gesture input or an audio input. By way of example, the first user 104A may evaluate the first set of user profiles associated with the first set of users attending the real-world event, displayed on the first user device 104. Thereafter, the first user 104A may select the one or more user profiles from the first set of the user profiles based on the evaluation. In an example, the first user 104A may decides to attend a “football match” (the first real-world event), that may be taking place at indoor stadium, Toronto on Jul. 7, 2024, at 3:00 pm. Then the processor 202 may render the first set of user profiles associated with the first set of users who may be attending the same football match. Thereafter, the first user 104A may scan or browse through the first set of user profiles associated with the first set of users including, but not limited to the second user 106A, the third user 112A, the fourth user 114A, and the fifth user 116A. Upon scanning, the first user 104A may decide to select the one or more user profiles associated with the second user 106A, the third user 112A, and the fifth user 116A. The selection may be based on various preferences of the first user 104A. Such preferences may include, for example, but not limited to demographic data, and shared interests. For example, the first user 104A may filter the one or more user profiles base on age range of the second user 106A, gender identity of the second user 106A, appearance of the second user 106A, interests and hobbies of the second user 106A, lifestyle choices of the second user 106A, and the like.

In an embodiment, once the first user 104A provides a selection of the desired event/activity, i.e., the first real-world event, to attend, the profile data of the first user 104A is placed in a match pool group with other users (namely, the first set of users) looking to attend the same first real-world event. Subsequently, the first user 104A will be able to view user profiles of the users in the first set of users. In an example, the first set of users may include the second user 106A, the third user 112A, the fourth user 114A and the fifth user 116A. In this regard, the first user 104A is able to view profiles of the second user 106A, the third user 112A, the fourth user 114A and the fifth user 116A via the user device 104. In an example, one user profile may be shown on the display of the user device 104 at a time. Moreover, the first user 104A may be able to view a single user profile through a swipe “yes” or “no” system. In other words, the first user 104A may view a profile of the second user 106A at a time. To this, the first user 104A may swipe “yes” or “no” to the profile of the second user 106A. Once the profile of the second user is swiped, a profile of the third user 112A may be rendered on the display of the first user device 104 for swiping. To this end, the profile of the second user 106A displayed on the first user device 104 may include profile data of the second user 106A. The profile data may indicate, for example, name, age, gender, hobbies, interests, photo, demographic data, or any other information that the second user 106A decides to disclose. Such information may be provided by the second user 106A while creating their account, or after the creation of the account. In certain cases, the profile data of the second user 106A may also indicate information associated with social media platforms, such as Facebook®, Instagram®, Snapchat®, Spotify®, and the like, used by the second user 106A.

In an example, a user profile may be associated with at least one of: an entertainer profile, an activity profile, an event host profile, an event attendee profile, or an event page. In an example, an entertainer profile may be user profiles that are created for entertainers, such as celebrities, influencers, and the like. This may help other users to see where, when and what events their favourite entertainers will be attending. For example, entertainers may attach and post such events to their profiles for users to see in their feed. In certain cases, the event host page or an event page may also include a list of entertainers that are attending their event. Further, the activity profile may enable the users to pick a date and time that works for them for attending a particular activity. For example, a user may be available on a Friday night and the user wants to go eat at their favorite bar/restaurant. In such a case, the usermay create an activity profile of the chosen date and time, say Friday, 13 Oct. 2024, 7:00 PM. The user may choose the date and time on a calendar to proceed to join a “match pool” of other users with the same chosen date available for joining the user to eat at the bar/restaurant specified by the user. In another example, a user may be looking for friends to go skiing with on a desired day. In such a case, the user may create an activity profile for skiing activity for a particular date and day. Other users of the server 104 may then swipe on the activity profile of the user based on whether they want to go for the skiing activity at the particular date and day or not.

The event host profile may be the profiles of an organizer or a host that may also be followed by other users. The event host profile may have a selection of upcoming events users can view and join that are organized or collaborated in by the organizer. In an example, the event host profile may also include a list of entertainers that will be attending their events. Users can then choose their desired event which will take them to the next slide, i.e., match with other users or attendees of the event and/or view other details of the event. The event attendee profile may be a user profile of a user who wants to attend an event or who has previously attended events organized by other organizers and/or hosts. It may be noted that all the user-related profiles may be considered as attendee profiles. Furthermore, the event page of an event may include details of the event. These details may include, but are not limited to, date and/or time of the event, number of people interested in the event, number of people going to the event, a joining link to join a match pool group to connect with other users attending or interested in the event, and/or tickets or link for buying tickets for the event. In an example, the event page may be mapped to one or more entertainer profiles associated with one or more entertainers attending or planning to attend the event. In another example, the event page may be mapped to one or more event host profiles associated with one or more event hosts or organizers hosting the event.

At 314, a request for meetup may be generated. In an embodiment, the processor 202 may be configured to generate a first notification indicative of the request to connect with the first user 104A at the first real-world event based on the second user input. The processor 202 may be configured to transmit the generated notification to the user devices. The first notification may correspond to for example, but not limited to an electronic mail, a text message, an alert message, a voice message and the like. Thereafter, the processor 202 may be further configured to receive a third user input to acknowledge the first notification by using the second user device 106 associated with the second user 106A. By way of example, each user associated with the one or more user profiles may receive the first notification on their corresponding user devices to connect with the first user 104A at the first real-world event. Upon reception of the first notification, the server 102 may allow each user to scan through a first user profile associated with the first user 104A. Thereafter, the processor 202 may be configured to receive the third user input to acknowledge the first notification. In an example, the second user 106A may provide the third user input indicative of a confirmation to meetup with the first user 104A at the first real-world event. In another example, the second user 106A may provide the third user input indicative of a rejection to the request to meetup with the first user 104A at the first real-world event. Thereafter, the processor 202 may be configured to transmit the acknowledgement associated with the first notification to the first user 104A based on the third user input.

Furthermore, the first user 104A may select one or more user profiles from the event attendee profiles from the first set of user profiles. For example, based on the display of the profile of the second user 106A, the first user 104A may swipe right on the profile. This may indicate a selection of the profile of the second user 104A. Based on the selection of the profile of the second user 106A, the first user 104A and the second user 106A may be matched. It may be noted that similar to a manner in which the first user 104A selected the second user 106A, the second user 106A may also have to select the first user 104A for a successful match between the first user 104A and the second user 106A. In a case where the first user 104A selects (or swipes right) the profile of the second user 106A while the second user 106A has not selected the profile of the first user 104A, then a notification may be sent to the second user 106A. However, in such a case, a request for meetup is not generated.

In addition, when the first user 104A and the second user 106A have matched, private a messaging platform may be enabled between the first user 104A and the second user 106A via the server 104. In particular, the messaging platform may be implemented over the network or the Internet without directly providing contact information of the users. The messaging platform gives the first user 104A the opportunity to connect via messages with the second user 106A. In certain cases, the first user 104A may also see or view what event/activity the second user 106A will be attending. Such view of events attended by the second user 106A will be based on approval or consent of the second user 106A. Thereafter, the possibility of the first user 104A and the second user 106A meeting up at the real-world event/activity reveals itself.

At 316, location information may be rendered. Upon confirmation to meetup, the processor 202 may be configured to render the location information associated with the first real-world event, on the first user device 104 and the second user device 106. Further, the location information includes a location scheduled to meetup at the first real-world event. In an example, the location scheduled to meetup may be the geographical location where the first real-world event may be arranged. In another example, the location scheduled to meetup may be decided by the first user 104A, and the second user 106A.

The present disclosure facilitates the first user 104A to make social connections at the real-world event. The proposed server 102 may allow the first user 104A to discover the real-world event that may be attended, based on his or her preferences or interests. Further, the server 102 may determine a group of individuals (the first set of users) attending the same real-world event. This may enable the first user 104A to socialise at the real-world event, thereby enhancing the user experience of the real-world event and creating meaningful in-person connections. Further, the server 102 may foster a sense of community by connecting individuals with similar interests, thereby mitigating limitations associated with online networking.

FIG. 4 is a diagram that illustrates exemplary operations for determining scores for each user profile, in accordance with an embodiment of the disclosure. FIG. 4 is explained in conjunction with elements from FIGS. 1, 2, and 3. With reference to FIG. 4, there is shown the block diagram 400 that may include one or more operations performed by any computing system, apparatus, or device, such as by the server 102 of FIG. 1 or the processor 202 of FIG. 2. Although illustrates with discrete blocks, the exemplary operations associated with one or more blocks of the block diagram 400 may be divided into additional blocks, combined into fewer blocks, or eliminated, depending on the implementation.

In an operation, the server 102 may be configured to retrieve the set of user profiles 108 stored in a database (for example, the memory 204) The set of user profile 108 may include a first user profile 402 associated with the first user 104A, and a first set of user profiles 404 associated with the first set of users attending the first real-world event. The first user profile 402 may include the demographic data associated with the first user 104A, and the preference data associated with the first user 104A, for example, but not limited to, an age, a gender, an educational background, marital status, club affiliations, organizational affiliations, hobbies, interests, profession, sexual orientation, annual income, sporting team preferences, relationship status, musical preferences, entertainment preferences, and food preferences.

In an embodiment, the server 102 may be further configured to compare the first user profile 402 and each of the first set of user profiles 404. For example, the server 102 may compare the first user profile 402 and a second user profile based on various factors, such as, but not limited to, a geographic proximity, a gender preference, an age group, interests, and the like.

At 406, a score may be determined. In an embodiment, the server 102 may be configured to determine the score for each of the first set of user profiles based on the comparison. In an example, upon comparing the first user profile 402 and the second user profile, the server 102 may determine the score based on similarities between the first user profile 402 and each of the first set of user profiles 404. For example, if an amount of information that matches between the first user profile 402 and the second user profile is high, the server 102 may generate a high score for the second user profile based on the similarities. On the contrary, if an amount of information that matches between the first user profile 402 and the second user profile is low, the server 102 may generate a low score for the second user profile.

Further, the server 102 may render each of the first set of user profiles 404 on the first user device 104 based on the determined score. In an example, each of the first set of user profiles 404 may be displayed on the first user device 104 a decreasing order of the determined score. In another example, each of the first set of user profiles 404 may be displayed on the first user device 104 an increasing order of the determined score.

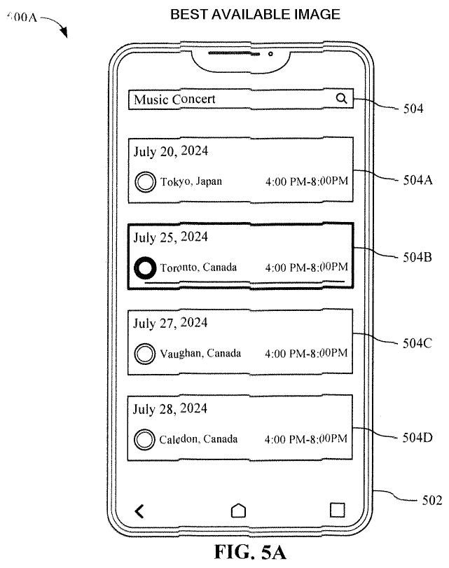

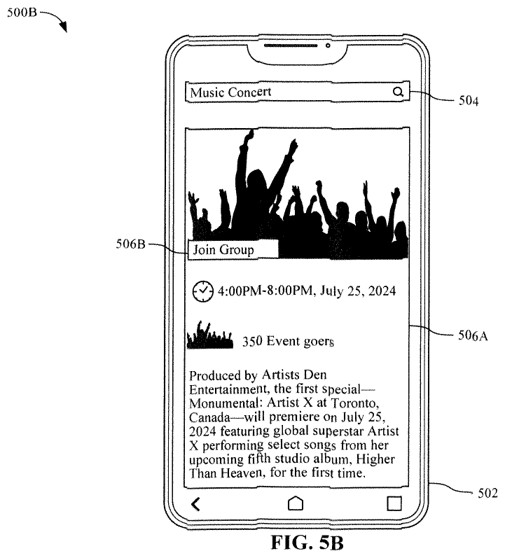

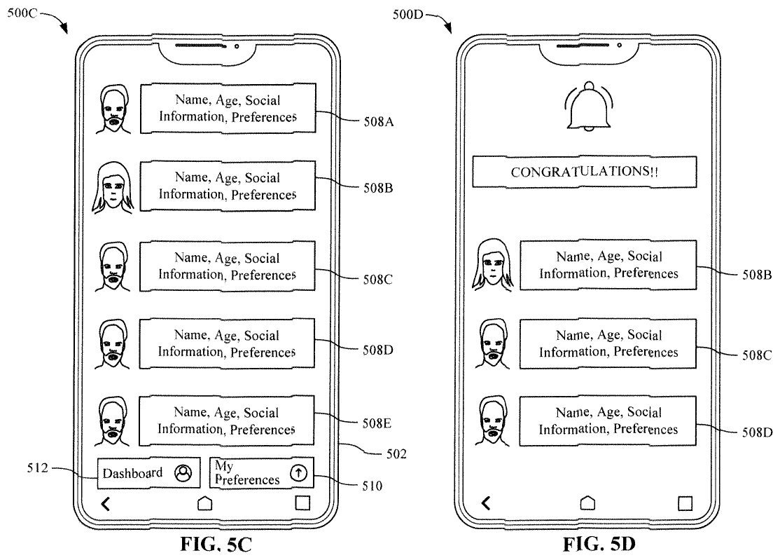

FIG. 5A, FIG. 5B, FIG. 5C, FIG. 5D, FIG. 5E and FIG. 5F illustrate exemplary user interfaces for connecting users in the real-world event, in accordance with an embodiment of the disclosure. Elements of the FIG. 5A, FIG. 5B, FIG. 5C, FIG. 5D, FIG. 5E and FIG. 5F are explained in conjunction with elements from FIG. 1, FIG. 2, FIG. 3, and FIG. 4. With reference to FIG. 5A, FIG. 5B, FIG. 5C, FIG. 5D, FIG. 5E and FIG. 5F there are shown exemplary user interfaces for connecting users in the real-world event. In an embodiment, the exemplary user interfaces may be rendered on the first user device 502 associated with the first user 104A. It is to be noted that the first user device 502 is an example of the first user device 104 of FIG. 1.

Referring to FIG. 5A, there is shown a user interface 500A. The user interface 500A includes a text box 504 that allows the first user 104A to input the first search query associated with the first real-world event on the first user device 502. As shown, the text box 504 includes the first search query, for example, “music concert”. Further, the processor 202 may be configured to determine the set of real-world events based on the first search query. The processor 202 may renders the set of real-world events on the first user device 502 based on the determination. For example, there is shown the set of real-world events such as, but not limited to a first event 504A, a second event 504B, a third event 504C, and a fourth event 504D, on the first user device 502. Each of the set of real-world events include event data 204A associated therewith. For example, the first event 504A may include the location information such as Tokyo Japan, and the timestamp information for example, time of the event 4:00 PM to 8:00 PM, date of the event Jul. 20, 2024. In an example, the second event 504B may include the location information such as Toronto, Canada, and the timestamp information for example, time of the event 4:00 PM to 8:00 PM, date of the event Jul. 25, 2024. In another example, the third event 504C may include the location information such as Vaughan, Canada, and the timestamp information for example, time of the event 4:00 PM to 8:00 PM, date of the event Jul. 27, 2024. In yet another embodiment, the fourth event 504D may include the location information such as Caledon, Canada, and the timestamp information for example, time of the event 4:00 PM to 8:00 PM, date of the event Jul. 28, 2024.

In an embodiment, the first user 104A may scan through the rendered set of real-world events, and the server 102 receives the first user input indicative of the selection of the first real-world event. As shown in the FIG. 5A, the user selection may be displayed with a rectangular box with thickened boundaries around the second event 504B

Referring to FIG. 5B, there is shown a user interface 500B. The user interface 500B further includes a text field 506 that allow the first user 104A to view event data associated with the selected second event 504B. As shown, the text field 506 may include a number of individuals for example, the first set of users attending the second event 504B, such as 350. The text field 506 may further include information associated with the second event 504B, such as “Produced by artists den entertainment, the first special monumental: artist X at Toronto, Canada will premiere on Jul. 25, 2024, featuring global superstar artist X performing select songs from her upcoming fifth studio album, higher than heaven, for the first time.”

Referring to FIG. 5C, there is shown a user interface 500C. The user interface 500C includes a first set of user profiles associated with the first set of users attending the second event 504B. For example, there is shown the first set of user profiles such as, but not limited to a first user profile 508A, a second user profile 508B, a third user profile 508C, a fourth user profile 508D, and fifth user profile 508E, on the first user device 502. Each of the s first set of user profiles include demographic data and the preference data associated with the corresponding user. For example, but not limited to a name, an age, social information, and preferences.

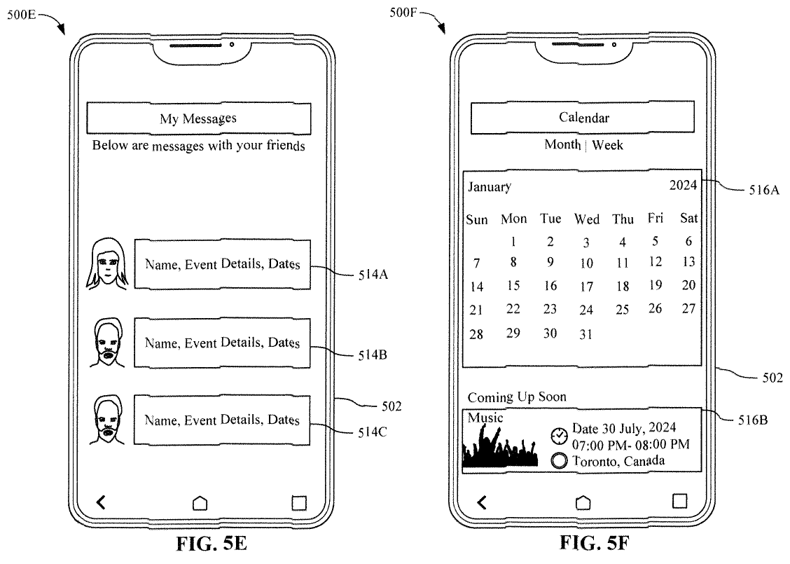

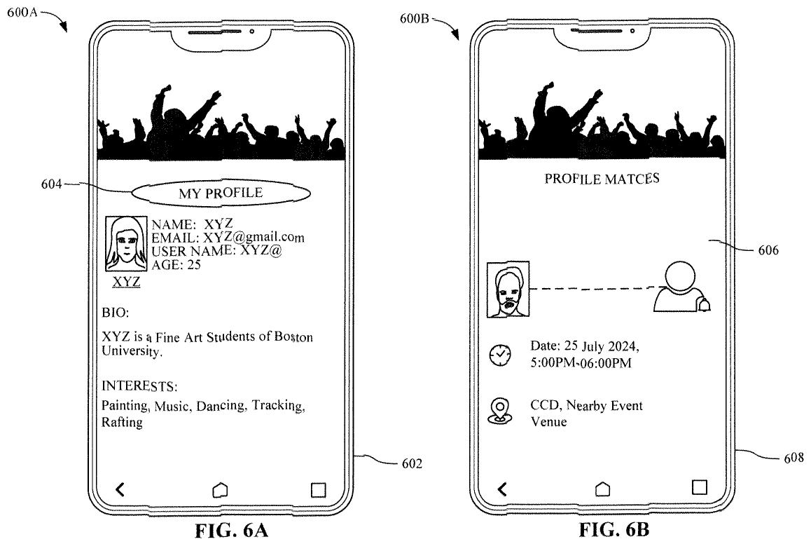

The user interface 500C further includes a dashboard icon 512 that may include, but not limited to, the demographic data associated with the first user 104A. Further, the user interface 500C includes my preferences tab 510 associated with the first user 104A, including the preference data associated with the first user 104A. In an example, the first user 104A may input his personal demographic data and the preference data to generate a first user profile, as shown in FIG. 6A.

Upon rendering of the first set of user profiles, the server 102 may receive the second user input to select one or more user profiles from the first set of profiles. In an example, the first user 104A may view the information about the first set of user profiles who are attending the real-world event. Thereafter, the server 102 may be configured to generate the first notification indicative of the request to meetup and transmit the first notification for rendering onto the second user device, as shown in FIG. 6B. Once the second user acknowledges the request to meetup, the first user 104A may be notified regarding the acceptance of the request to connect.

Referring to FIG. 5D, there is shown a user interface 500D. The user interface 500D includes the one or more user profiles that may have accepted the request from the first user 104A to connect therewith. For example, the notification on the first user device 502 may display, for example, “CONGRATULATIONS! !” along with the second user profile 508B, the third user profile 508C and the fourth user profile 508D associated with the one or more users that may be connecting with the first user 104A at the real-world event.

Referring to FIG. 5E, there is shown a user interface 500E. The user interface 500E includes the one or more user profiles that may have accepted the request from the first user 104A to connect therewith. Subsequently, the first user 104A may get a messaging platform displayed on the first user device 502 to connect with one or more users of the one or more user profiles. For example, the first user device 502 may display, for example, “My messages” along with profile details associated with the second user profile 508B, the third user profile 508C and the fourth user profile 508D associated with the one or more users that may be connecting with the first user 104A at the real-world event. In addition, the first user device 502 may display, for example, the event details associated with the real-world event to which the first user 104A and the one or more users are going, as well as date of match and/or date of the event. Moreover, the first user device 502 may display a message profile 514A associated with the second user profile 508B, a message profile 514B associated with the third user profile 508C, and a message profile 514C associated with the fourth user profile 508D.

Referring to FIG. 5F, is shown a user interface 500E. The user interface 500E includes a calendar 516A that is a user personal calendar of the first user 104A associated with the application. The calendar 516A allows the first user 104A to see a view 516B indicating what events they have in the upcoming days and also get notified.

FIG. 6A illustrates exemplary user interface associated with display of a first user profile, in accordance with an embodiment of the disclosure. Elements of the FIG. 6A is explained in conjunction with elements from FIG. 1, FIG. 2, FIG. 3, FIG. 4, FIG. 5A, FIG. 5B, FIG. 5C and FIG. 5D. With reference to FIG. 6A, there is shown exemplary user interface associated with display of a first user profile associated with the first user 104A. In an embodiment, the exemplary user interface 600A may be rendered on the first user device 602 associated with the first user 104A. It is to be noted that the first user device 602 is an example of the first user device 104 of FIG. 1.

The user interface 600A includes the first user profile 604 associated with the first user 104A. The user interface 600A further includes, but is not limited to, a user profile image, a name, an age, a username, an email address, and interests. As shown, a bio section may include a short introduction for the first user 104A such as “XYZ is a fine art student at Boston university.” Further the interest section includes interest such as painting, music, dancing, tracking, and rafting.

FIG. 6B illustrates exemplary user interface associated with rendering of the first notification on a second user device, in accordance with an embodiment of the disclosure. Elements of the FIG. 6B is explained in conjunction with elements from FIG. 1, FIG. 2, FIG. 3, FIG. 4, FIG. 5A, FIG. 5B, FIG. 5C, FIG. 5D and FIG. 6A. With reference to FIG. 6B, there is shown exemplary user interface associated with rendering of the first notification on a second user device 608. In an embodiment, the exemplary user interface 600B may be rendered on the second user device 608 associated with the second user 106A. It is to be noted that the second user device 608 is an example of the second user device 106 of FIG. 1.

The user interface 600B includes the first notification 606 indicative of a request for connection from the first user 104A to the second user 106A. Upon, selection of the one or more users attending the real-world event, the server 102 may transmit the first notification 606 indicative of the request to meetup. As shown, the second user 106A will get notification associated with the first user profile 604 on the second user device 608 associated with the second user 106A. For example, notification may be a text message, an email, or through any web service. The first notification 606 may include the location information to meet up at the first real-world event on the second user device 106. For example, as shown in FIG. 6B, location information includes, for example, but not limited to, “CCD, nearby event venue”, and the timestamp information include, for example, but not limited to, time of the meetup 5:00 PM to 6:00 PM, and date of the event Jul. 25, 2024.

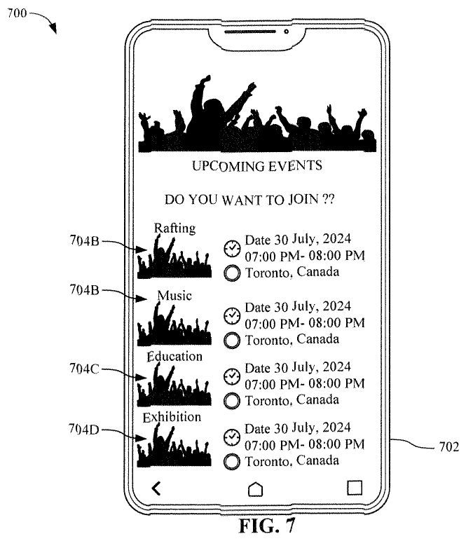

FIG. 7 illustrates exemplary user interface for notifying users about the real-world event, in accordance with an embodiment of the disclosure. Elements of the FIG. 7 is explained in conjunction with elements from FIG. 1, FIG. 2, FIG. 3, FIG. 4, FIG. 5A, FIG. 5B, FIG. 5C, FIG. 5D, FIG. 6A and FIG. 6B. With reference to FIG. 7, there is shown exemplary user interface for notifying users about the real-world event. In an embodiment, the exemplary user interface 700 may be rendered on the first user device 702 associated with the first user 104A. It is to be noted that the first user device 702 is an example of the first user device 104 of FIG. 1.

In an embodiment, the server 102 may be configured to generate a second notification pertaining to a request to attend the first real-world event. The second notification may include, for example, a list of upcoming events, that may be displayed on the user devices (for example, but not limited to, the first user device 104, the second user device 106, the third user device 112, the fourth user device 114, and the fifth user device 116). By way of example, the one or more hosts may invite the set of users to a real-world event. In an example, the one or more hosts may correspond to an event organizing group, for example, but not limited to, event planning agency who organize one or more events for a large gathering. In another example, the one or more hosts may correspond to an individual planning for an activity, such as but not limited to an adventure trip. In such an example, one or more hosts may be looking for a partner for the activity. In an example, the event data in such a scenario may be determined by the host of the real-world event.

For example, there is shown the set of real-world events such as, but not limited to a first event 704A, a second event 704B, a third event 704C, and a fourth event 704D, on the first user device 702. Each of the set of real-world events include event data 204A associated therewith. For example, the first event 704A may correspond to a rafting event including the location information such as Toronto, Canada, and the timestamp information for example, time of the event 7:00 PM to 8:00 PM, date of the event Jul. 30, 2024. In an example, the second event 704B may correspond toa music event including the location information such as Toronto, Canada, and the timestamp information for example, time of the event 7:00 PM to 8:00 PM, date of the event Jul. 30, 2024. In another example, the third event 704C may correspond to an educational fair including the location information such as Toronto, Canada, and the timestamp information for example, time of the event 7:00 PM to 8:00 PM, date of the event Jul. 30, 2024. In yet another embodiment, the fourth event 704D may correspond to an exhibition including the location information such as Toronto, Canada, and the timestamp information for example, time of the event 7:00 PM to 8:00 PM, date of the event Jul. 30, 2024.

FIG. 8 is a flowchart that illustrates an exemplary method for facilitating social connections between users in a real-world event, in accordance with an embodiment of the disclosure. FIG. 8 is explained in conjunction with elements from FIGS. 1, 2, 3, 4, 5A, 5B, 5C, 5D, 6A, 6B, and 7. With reference to FIG. 8, there is shown the flowchart 800. The operations of the exemplary method may be executed by any computing system, for example, by the server 102 of FIG. 1 or the processor 202 of FIG. 2. The operations of the flowchart 800 may start at 802.

At 802, a first user input may be received. In an embodiment, the processor 202 may be configured to receive the first user input indicative of a selection of a first real-world event to be attended by the first user 104A. The first user input may be received from a first user device 104 associated with the first user 104A.

At 804, a first set of users may be determined. In an embodiment, the processor 202 may be configured to determine the first set of users, from a set of users, attending the first real-world event based on the received first user input. The first set of users may include at least a second user.

At 806, a first set of user profiles may be rendered. In an embodiment, the processor 202 may be configured to render the first set of user profiles associated with the first set of users on the first user device 104.

At 808, location information may be rendered. In an embodiment, the processor 202 may be configured to render the location information associated with the first real-world event, on the first user device 104 and the second user device 106 associated with the second user 106A. The location information may include a location scheduled to meetup at the first real-world event. Control may pass to end.

Alternatively, the server 102 may comprise means for performing each of the operations described above. In this regard, according to an example embodiment, examples of means for performing operations may comprise, for example, the processor and/or a device or circuit for executing instructions or executing an algorithm for processing information as described above.

Various embodiments of the disclosure may provide a non-transitory computer-readable medium and/or storage medium having stored thereon, instructions executable by a machine and/or a computer to operate a system (e.g., the server 102) for facilitating social connections between users in real-world event. The instructions may cause the machine and/or computer to perform operations including receiving a first user input indicative of a selection of a first real-world event to be attended by a first user. The first user input is received from a first user device associated with the first user. The operations may further include determining a first set of users, from a set of users, attending the first real-world event based on the received first user input. The first set of users may include at least a second user. The operations may further include rendering a first set of user profiles associated with the first set of users on the first user device and rendering location information associated with the first real-world event, on the first user device and a second user device associated with the second user. The location information includes a location scheduled to meetup at the first real-world event.

Many modifications and other embodiments of the inventions set forth herein will come to mind to one skilled in the art to which these inventions pertain having the benefit of the teachings presented in the foregoing descriptions and the associated drawings. It is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A server, comprising:
a memory to store computer-executable instructions; and
a processor configured to execute the computer-executable instructions to perform the following actions:
receive a first user input indicative of a selection of a first real-world event to be attended by a first user, wherein the first user input is received from a first user device associated with the first user;
determine a first set of users, from a set of users, attending the first real-world event based on the received first user input, wherein the first set of users comprises at least a second user;
render a first set of user profiles associated with the first set of users on the first user device; and
render location information associated with the first real-world event, on the first user device and a second user device associated with the second user, wherein the location information comprises a location scheduled to meetup at the first real-world event.

2. The server of claim 1, wherein the processor is further configured to:
receive a second user input indicative of a selection of one or more user profiles from the first set of user profiles, using the first user device;
generate a first notification indicative of a request to connect with the first user at the first real-world event based on the second user input;
transmit the first notification to the second user device; and
render the first notification.

3. The server of claim 2, wherein the processor is configured to:
receive a third user input to acknowledge the first notification, wherein the third user input is received from the second user device.

4. The server of claim 1, wherein the processor is further configured to:
receive a first search query pertaining to event data associated with the first real-world event, wherein the first search query is received from the first user device;
determine a first set of real-world events from a set of real-world events based on the received first search query;
render the first set of real-world events on the first user device; and
receive the first user input to select the first real-world event from the first set of real-world events.

5. The server of claim 4, wherein the event data associated with the first real-world event comprises event type information, location information, and timestamp information.

6. The server of claim 4, wherein the processor is further configured to:
receive the event data associated with the set of real-world events from one or more hosts; and
store the event data.

7. The server of claim 1, wherein the processor is further configured to:
generate a second notification pertaining to a request to attend the first real-world event;
transmit the second notification to the first user device; and
receive the first user input to select the first real-world event based on the second notification.

8. The server of claim 1, wherein each of the first set of user profiles associated with the first set of users comprises demographic data associated with a corresponding user of the first set of users, and preference data associated with the corresponding user of the first set of users.

9. The server of claim 1, wherein the processor is further configured to:
receive a first user profile associated with the first user, wherein the first user profile comprises demographic data associated with the first user, and preference data associated with the first user;
compare the first user profile and each of the first set of user profiles;
determine a score for each of the first set of user profiles based on the comparison; and
render the first set of user profiles on the first user device based on the determined score.

10. A method, comprising:
receiving a first user input indicative of a selection of a first real-world event to be attended by a first user, wherein the first user input is received from a first user device associated with the first user;
determining a first set of users, from a set of users, attending the first real-world event based on the received first user input, wherein the first set of users comprises at least a second user;
rendering a first set of user profiles associated with the first set of users on the first user device; and
rendering location information associated with the first real-world event, on the first user device and a second user device associated with the second user, wherein the location information comprises a location scheduled to meetup at the first real-world event.

11. The method of claim 10, further comprising:
receiving a second user input indicative of a selection of one or more user profiles from the first set of user profiles, using the first user device;
generating a first notification indicative of a request to connect with the first user at the first real-world event based on the second user input;
transmitting the first notification to the second user device; and
rendering the first notification.

12. The method of claim 11, further comprising:
receiving a third user input to acknowledge the first notification, wherein the third user input is received from the second user device.

13. The method of claim 10, further comprising:
receiving a first search query pertaining to event data associated with the first real-world event, wherein the first search query is received from the first user device;
determining a first set of real-world events from a set of real-world events based on the received first search query;
rendering the first set of real-world events on the first user device; and
receiving the first user input to select the first real-world event from the first set of real-world events.

14. The method of claim 13, wherein the event data associated with the first real-world event comprises event type information, location information, and timestamp information.

15. The method of claim 13, further comprising:
receiving the event data associated with the set of real-world events from one or more hosts; and
storing the event data.

16. The method of claim 10, further comprising:
generating a second notification pertaining to a request to attend the first real-world event;
transmitting the second notification to the first user device; and
receiving the first user input to select the first real-world event based on the second notification.

17. The method of claim 10, wherein each of the first set of user profiles associated with the first set of users comprises demographic data associated with a corresponding user of the first set of users, and preference data associated with the corresponding user of the first set of users.

18. The method of claim 10, further comprising:
receiving a first user profile associated with the first user, wherein the first user profile comprises demographic data associated with the first user, and preference data associated with the first user;
comparing the first user profile and each of the first set of user profiles;
determining a score for each of the first set of user profiles based on the comparison; and
rendering the first set of user profiles on the first user device based on the determined score.

19. A computer programmable product comprising a non-transitory computer readable medium having stored thereon computer executable instructions, which when executed by one or more processors, cause the one or more processors to conduct operations, comprising:
receiving a first user input indicative of a selection of a first real-world event to be attended by a first user, wherein the first user input is received from a first user device associated with the first user;
determining a first set of users, from a set of users, attending the first real-world event based on the received first user input, wherein the first set of users comprises at least a second user;
rendering a first set of user profiles associated with the first set of users on the first user device; and
rendering location information associated with the first real-world event, on the first user device and a second user device associated with the second user, wherein the location information comprises a location scheduled to meetup at the first real-world event.

20. The computer programmable product of claim 19, further comprising:
receiving a second user input indicative of a selection of one or more user profiles from the first set of user profiles, using the first user device;
generating a first notification indicative of a request to connect with the first user at the first real-world event based on the second user input;
transmitting the first notification to the second user device; and
rendering the first notification.
